(19) United States
(12) Patent Application Publication
(10) Pub. No.: US 2026/0155705 A1
(43) Pub. Date: Jun. 4, 2026

(54) ELECTRIC COMPRESSOR

(71) Applicant: Hanon Systems, Daejeon (KR)

(72) Inventors: Hyun Woo LEE, Daejeon (KR); Min Gyu KIM, Daejeon (KR); Sang Woo BAE, Daejeon (KR); Hye Rim AN, Daejeon (KR); Sung Taeg OH, Daejeon (KR)

(21) Appl. No.: 19/404,530

(22) Filed: Dec. 1, 2025

(30) Foreign Application Priority Data
Nov. 29, 2024 (KR) 10-2024-0175771

(51) Int. Cl. H02K 7/14; F04C 18/02; H02K 5/04; H02K 11/33

(52) U.S. Cl. CPC H02K 7/14; H02K 5/04; H02K 11/33; F04C 18/0215; F04C 2240/30; F04C 2240/403

(57) ABSTRACT

An electric compressor in which a through hole through which a terminal pin electrically connecting an inverter unit to a motor unit passes is formed in a partition wall, and the terminal pin is integrally injection-molded into the through hole together with a fixing unit, thereby sealing a gap between the terminal pin and a housing without a separate sealing member and an assembly member, and enabling modularization of the housing and the terminal pin.

### CROSS REFERENCE TO RELATED PATENT APPLICATIONS

The present application claims priority to Korean Patent Application No. 10-2024-0175771, filed Nov. 29, 2024, the entire contents of which are incorporated herein for all purposes by this reference.

### FIELD OF THE INVENTION

The present invention relates to an electric compressor, and more specifically, to an electric compressor in which a through hole through which a terminal pin electrically connecting an inverter unit to a motor unit passes is formed in a partition wall, and the terminal pin is integrally injection-molded into the through hole together with a fixing unit, thereby sealing a gap between the terminal pin and a housing without a separate sealing member and an assembly member, and enabling modularization of the housing and the terminal pin.

### BACKGROUND OF THE INVENTION

In electric compressors, a three-phase current generated from an inverter is transmitted to a motor through a three-phase pin, and conventionally, the pin that electrically connects the inverter and motor is glass-welded to a separate plate, and the plate is bolted to a motor housing.

Korean Patent No. 2018-0028304 discloses a conventional connector 5. The conventional connector 5 includes a terminal pin 52 that connects a motor 2 to an inverter 4 by passing through a terminal holder 51, the terminal holder 51 that supports the terminal pin 52 and seals a motor accommodation space S1 and an inverter accommodation space S2, and an insulator 53 that insulates between the terminal holder 51 and the terminal pin 52. The insulator 53 may be formed of a glass material. In addition, a sealing member 6 is additionally provided to seal an area in which the connector 5 is mounted to prevent leakage current due to refrigerant.

In this way, conventionally, assembly members (bolts and the like) are required to assemble the plate to the motor housing, and a separate sealing member (a gasket, an O-ring, a rubber, or the like) is required to prevent leakage between the plate, bolts, pins, and motor housing, and a portion of the motor housing on which the plate is seated needs to be surface-processed to make it even, and thus there is a problem that the number of components increases and additional processing and assembly work are required, which increases prices of products.

In addition, since fastening is performed using bolts, there is a problem that there is a high risk of leakage of refrigerant inside the motor housing when an axial force of the bolt is insufficient.

### SUMMARY OF THE INVENTION

The present invention is directed to providing an electric compressor in which a through hole through which a terminal pin electrically connecting an inverter unit to a motor unit passes is formed in a partition wall, and the terminal pin is integrally injection-molded into the through hole together with a fixing unit, thereby sealing a gap between the terminal pin and a housing without a separate sealing member and an assembly member, and enabling modularization of the housing and the terminal pin.

Objects of the present invention are not limited to the above object, and other objects that are not described will be able to be clearly understood by those skilled in the art to which the present invention pertains based on the following description.

According to one embodiment of the present invention, there is provided an electric compressor including a housing in which a compression unit for compressing refrigerant and a motor unit for driving the compression unit are disposed and in which refrigerant flows, and an inverter unit that is disposed on one side of the housing and controls the motor unit, wherein a plurality of through holes are formed in a partition wall located between the motor unit and the inverter unit, and the electric compressor further includes a plurality of terminal pins electrically connecting the motor unit to the inverter unit by passing through the plurality of through holes, respectively, and a fixing unit having a plurality of first injection-molded portions injection-molded into the through holes, respectively, while surrounding at least a portion of each terminal pin.

According to an embodiment, the fixing unit may be injection-molded using a plastic material.

According to an embodiment, the fixing unit may further have a first injection-molded surface that comes into contact with one end surface of the partition wall facing the motor unit and connects the plurality of first injection-molded portions and a second injection-molded surface that comes into contact with the other end surface of the partition wall facing the inverter unit and connects the plurality of first injection-molded portions.

According to an embodiment, a width w1 of the first injection-molded surface and a width w2 of the second injection-molded surface in a direction perpendicular to a direction in which the plurality of terminal pins are spaced apart from each other may be larger than a maximum width d1 of a cross section of the first injection-molded portion.

According to an embodiment, the first injection-molded surface may be formed to be wider than the second injection-molded surface.

According to an embodiment, a first seating surface recessed so that the first injection-molded surface is seated may be formed on the one end surface of the partition wall and a second seating surface recessed so that the second injection-molded surface is seated may be formed on the other end surface of the partition wall.

According to an embodiment, an adhesive may be applied to a portion of the one end surface of the partition wall with which the first injection-molded surface comes into contact and a portion of the other end surface of the partition wall with which the second injection-molded surface comes into contact.

According to an embodiment, the fixing unit may further have a plurality of second injection-molded portions extending outward from the first injection-molded surface to surround at least a portion of each terminal pin and a plurality of third injection-molded portions extending outward from the second injection-molded surface to surround at least a portion of each terminal pin.

According to an embodiment, a maximum width d2 of a cross section of the second injection-molded portion and a maximum width d3 of a cross section of the third injection-molded portion are larger than the maximum width d1 of the cross section of the first injection-molded portion.

According to an embodiment, a slot may be formed in an inner surface of the partition wall forming the through hole, and the first injection-molded portion may have a protrusion inserted into the slot.

According to an embodiment, the through hole may have a counterbore shape in which a width of both ends increases outward, and a stepped portion corresponding to the counterbore shape may be provided on both ends of the first injection-molded portion.

According to an embodiment, a minimum diameter d4 of the through hole may be 2 mm or more larger than an outer diameter d5 of the terminal pin.

According to an embodiment, a central portion of the terminal pin disposed inside the first injection-molded portion may have an uneven shape.

According to an embodiment, each of the terminal pins may include a cylindrical portion having a hollow at both ends, and a deformation portion disposed between the cylindrical portions at both ends and surrounded by the fixing unit.

According to an embodiment, the fixing unit may be injection-molded to the hollows of the cylindrical portions at both ends.

### BRIEF DESCRIPTION OF THE DRAWINGS

FIG. 1 is a schematic cross-sectional view showing an electric compressor according to one embodiment of the present invention.

FIG. 2 is a front view showing a portion of a motor housing of FIG. 1.

FIG. 3 is a rear view of FIG. 2.

FIG. 4 is a cross-sectional perspective view of a portion of FIG. 2.

FIG. 5 is a cross-sectional view of FIG. 4.

FIG. 6 is a front view showing a portion of FIG. 2 with a terminal pin and a fixing unit separated.

FIG. 7 is a perspective view separately showing the terminal pin and the fixing unit in FIG. 2.

FIG. 8 is a side view of FIG. 7.

FIG. 9 is a side view separately showing the terminal pin in FIG. 8.

FIG. 10 is a side view separately showing the fixing unit in FIG. 8.

FIG. 11 is a cross-sectional view showing a portion of an electric compressor according to a second embodiment of the present invention.

FIG. 12 is a cross-sectional perspective view showing a portion of FIG. 11 with a terminal pin and a fixing unit separated.

FIG. 13 is a cross-sectional view showing a portion of an electric compressor according to a third embodiment of the present invention.

FIG. 14 is a cross-sectional perspective view showing a portion of FIG. 13 with a terminal pin and a fixing part separated.

FIG. 15 is a cross-sectional view showing a portion of an electric compressor according to a fourth embodiment of the present invention.

### DETAILED DESCRIPTION OF THE INVENTION

Hereinafter, exemplary embodiments of an electric compressor of the present invention will be described with reference to the accompanying drawings.

In addition, terms to be described below are terms defined in consideration of functions of the present invention and may vary depending on the intention or custom of a user or operator, and the following embodiments do not limit the scope of the present invention, but are merely exemplary matters of components presented in the claims of the present invention.

To clearly describe the present invention, parts not related to the description have been omitted, and the same or similar components are denoted by the same reference numerals throughout the specification. Throughout the specification, when a certain part is described as “including” a certain component, this means further including another component rather than precluding another component unless especially stated otherwise.

In addition, components described as “˜unit” throughout the specification may be two or more components combined into one component, or one component may be divided into two or more components according to more subdivided functions. In addition, it is obvious that each component to be described below may additionally perform some or all of functions of which other components are in charge in addition to a main function of which each component is in charge, and some of the main functions of which each component is in charge may be performed by being dedicated by other components.

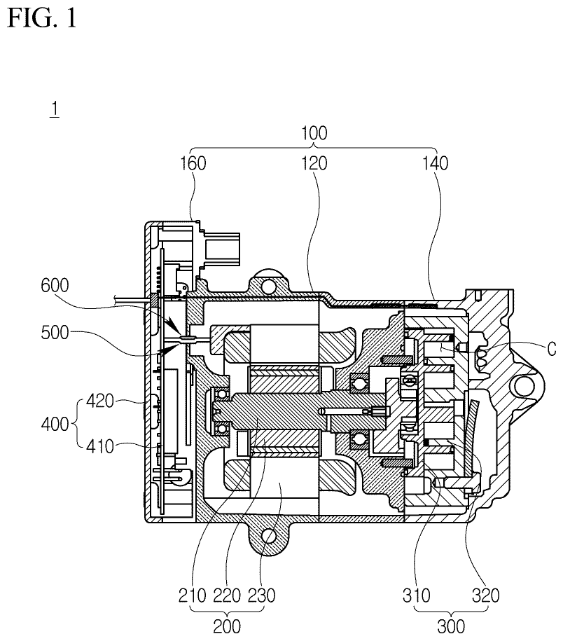

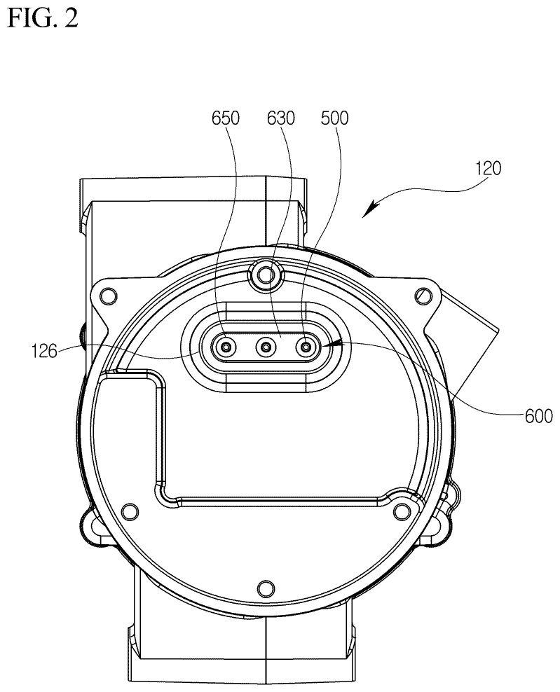

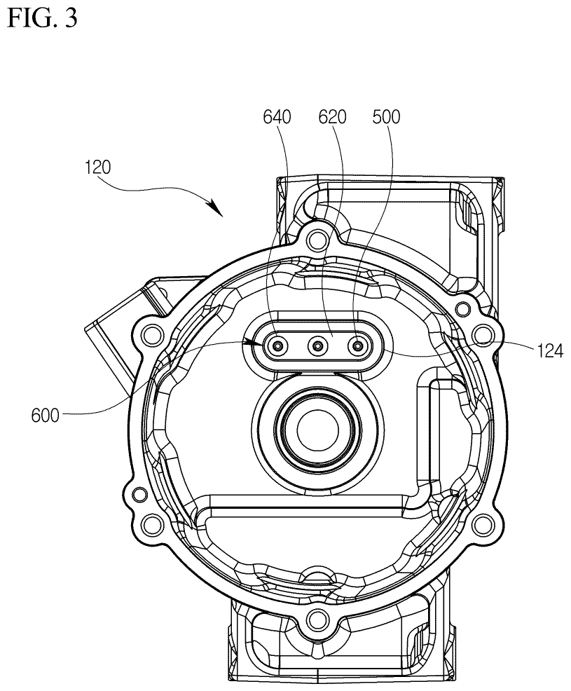

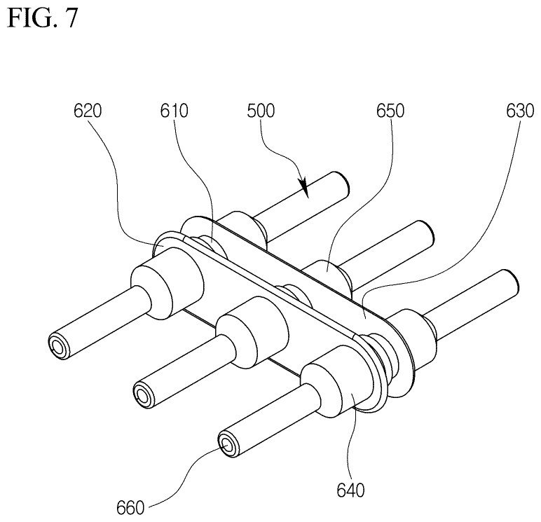

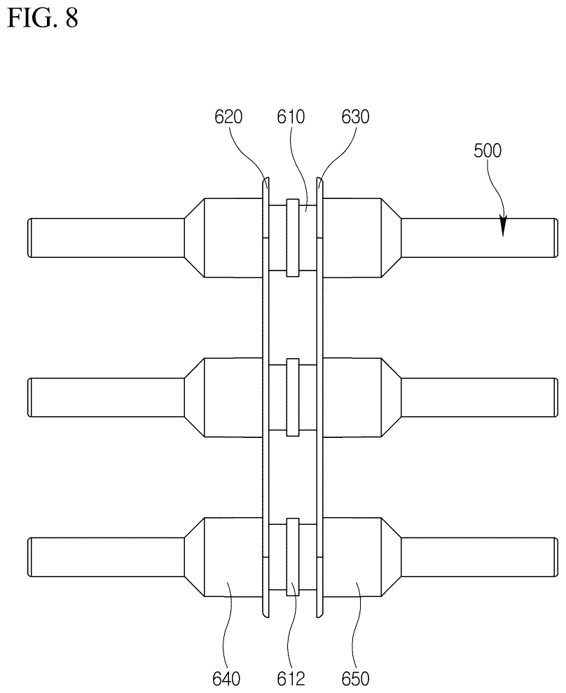

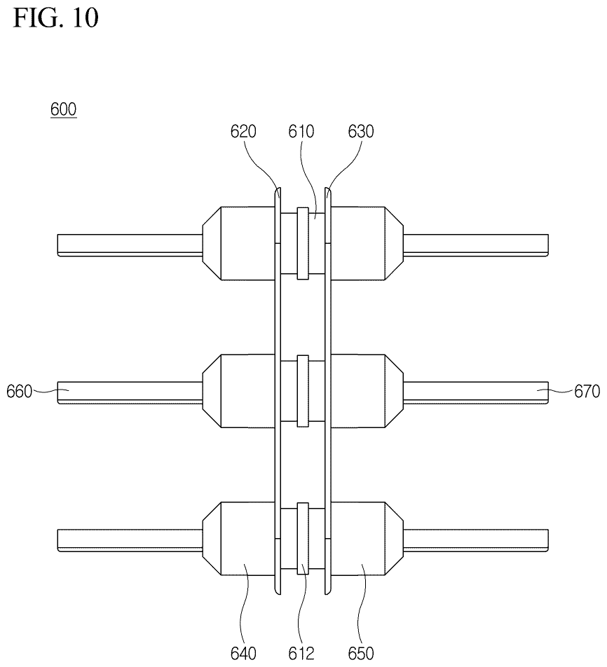

First, an electric compressor 1 according to one embodiment of the present invention will be described with reference to FIGS. 1 to 10.

The electric compressor 1 of the present invention includes a housing 100, a motor unit 200, a compression unit 300, an inverter unit 400, a terminal pin 500, and a fixing unit 600.

The housing 100 forms the overall exterior of the electric compressor 1, and refrigerant flows inside the housing. In the present embodiment, the housing 100 is composed of a motor housing 120, a compression housing 140, and an inverter housing 160.

The motor unit 200 is provided in the motor housing 120, and the compression unit 300 provides power for compressing the refrigerant. Specifically, the motor unit 200 includes a rotational shaft 210 rotatably installed at the center of the motor housing 120, a rotor 220 installed on the rotational shaft 210, and a stator 230 fixed to the motor housing 120 and disposed radially outside the rotor 220. In addition, the stator 230 includes a stator core and a coil wound around the stator core.

The stator 230 generates an electromagnetic field by power applied from the inverter unit 400 to be described below, and as the rotor 220 is rotated by the electromagnetic field generated by the stator 230, a rotational force for driving the compression unit 300 is generated.

The compression unit 300 compresses refrigerant flowing into the housing 100. In the present embodiment, the compression unit 300 provided in the compression housing 140 specifically includes an orbiting scroll 310 coupled to the rotational shaft 210 through an eccentric bush, and a fixed scroll 320 forming a compression chamber C in which the refrigerant is compressed together with the orbiting scroll 310. In this way, since the compression unit 300 is connected to the motor unit 200 through the rotational shaft 210, the rotational force generated from the motor unit 200 may be transmitted to the orbiting scroll 310 of the compression unit 300 by the rotational shaft 210. However, the present invention is not limited thereto, and it is obvious that a compression unit of another type may be used.

The inverter unit 400 is disposed on a side opposite to the compression unit 300 with respect to the motor unit 200 at one side of the motor housing 120. The inverter unit 400 is electrically connected to the motor unit 200 and supplies power to the motor unit 200 to control its operation through power and control signals transmitted from the outside.

In FIG. 1, an example in which the inverter housing 160 is a separate housing in which a portion of the inverter unit 400 is disposed, but in some cases, the inverter housing 160 may be integrally formed with the motor housing 120.

The inverter unit 400 may include a circuit board 410 to which switching elements are connected, and an inverter cover 420 that is coupled to the inverter housing 160 so that the circuit board 410 is accommodated and protects the circuit board 410 from an external impact and the like.

In this case, the motor unit 200 and the inverter unit 400 are electrically connected by the terminal pin 500. In the present embodiment, since a 3-phase motor unit 200 is used, three terminal pins 500 connected to three phases, respectively, are provided to supply 3-phase power from the inverter unit 400 to the motor unit 200. The three terminal pins 500 are electrically connected to 3-phase coils of the stator 230, respectively, and extend into the inverter unit 400 after passing through the motor housing 120. Each of the three terminal pins 500 also passes through the circuit board 410 of the inverter unit and is electrically connected to the circuit board 410.

Hereinafter, a structure in which the three terminal pins 500 are integrally modularized into the motor housing 120 by the fixing unit 600 will be described in detail.

A plurality of through holes 122 are formed in the partition wall located between the motor unit 200 and the inverter unit 400. In the present embodiment, the partition wall corresponds to a portion of the motor housing 120, but according to another modified example, the partition wall may be formed as a portion of the inverter housing 160 or as a separate housing.

In the present embodiment, three through holes 122 are formed in parallel and spaced apart from each other to correspond to three terminal pins 500. The three terminal pins 500 pass through three through holes 122, respectively.

In the present invention, as the fixing unit 600 is injection-molded in a state in which the three terminal pins 500 has passed through the three through holes 122, respectively, the three terminal pins 500 are integrally modularized with the motor housing 120. Accordingly, gaps between the terminal pins 500 and the motor housing 120 may be sealed without a separate sealing member and assembly member, and the motor housing 120 and the terminal pins 500 may be modularized. In this way, when the terminal pins 500 are integrally formed with the motor housing 120 through the fixing unit 600, unlike the conventional one, since the assembly member and the sealing member are not required, the number of components and the assembly work can be reduced, and the weight can also be reduced.

The fixing unit 600 is injection-molded into each through hole 122 while surrounding at least a portion of each terminal pin 500. The fixing unit 600 is essentially injection-molded into each through hole 122 and may extend beyond the through hole 122 toward the motor unit 200 and the inverter unit 400 as needed.

In the present embodiment, the fixing unit 600 is injection-molded using a plastic material. That is, the fixing unit 600 is a plastic resin injection-molded product. Accordingly, the cost can be reduced compared to glass welding used conventionally.

The fixed unit 600 may specifically have a plurality of first injection-molded portions 610 injection-molded into the through holes 122, respectively, a first injection-molded surface 620 that comes into contact with one end surface of the partition wall of the motor housing 120 facing the motor unit 200 and connects the plurality of first injection-molded portions 610, and a second injection-molded surface 630 that comes into contact with the other end surface of the partition wall of the motor housing 120 facing the inverter unit 400 and connects the plurality of first injection-molded portions 610. The first injection-molded portion 610 has a cylindrical shape corresponding to the shape of the through hole 122, and the first injection-molded surface 620 and the second injection-molded surface 630 have a flat shape.

As the first injection-molded surface 620 and the second injection-molded surface 630 are formed in this way, the fixed unit 600 can be prevented from moving (being pushed) toward the motor unit 200 or the inverter unit 400, and since the fixed unit 600 may come into contact with not only the through hole 122 but also metal surfaces between adjacent terminal pins 500, a contact surface between the fixed unit 600 and the motor housing 120 may be formed maximally.

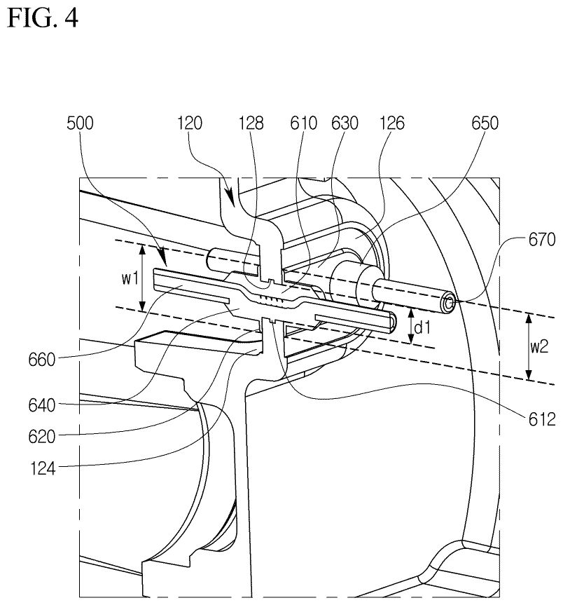

In this case, in order to effectively prevent the movement of the fixed unit 600, as shown in FIG. 4, a width w1 of the first injection-molded surface 620 and a width w2 of the second injection-molded surface 630 in a direction perpendicular to a direction in which the plurality of terminal pins 500 are spaced apart from each other are preferably larger than a maximum width d1 of a cross section of the first injection-molded portion 610. In the present embodiment, the width w1 of the first injection-molded surface 620 and the width w2 of the second injection-molded surface 630 are the same.

As needed, a first seating surface 124 recessed so that the first injection-molded surface 620 is seated may be formed on the one end surface of the partition wall of the motor housing 120, and a second seating surface 126 recessed so that the second injection-molded surface 630 is seated may be formed on the other end surface of the partition wall of the motor housing 120. In the present embodiment, the first seating surface 124 and the second seating surface 126 are formed to be wider than the first injection-molded surface 620 and the second injection-molded surface 630, but are not limited thereto.

In order to increase adhesion between the metal surface of the motor housing 120 and the fixing unit 600 that is injection-molded using a plastic material as needed, an adhesive may be applied or surface-treated on a portion of one end surface of the partition wall of the motor housing 120 with which the first injection-molded surface 620 comes into contact and a portion of the other end of the partition wall of the motor housing 120 with which the second injection-molded surface 630 comes into contact.

In the present embodiment, in order to additionally secure the location of the terminal pin 500, a slot 128 is formed in an inner surface of the partition wall of the motor housing 120 forming the through hole 122, and a protrusion 612 inserted into the slot 128 is provided on the first injection-molded portion 610.

Furthermore, the fixed unit 600 may further have a plurality of second injection-molded portions 640 extending outward from the first injection-molded surface 620 so as to surround at least a portion of each terminal pin 500, and a plurality of third injection-molded portions 650 extending outward from the second injection-molded surface 630 so as to surround at least a portion of each terminal pin 500. The second injection-molded portion 640 and the third injection-molded portion 650 may have a cylindrical shape like the first injection-molded portion 610.

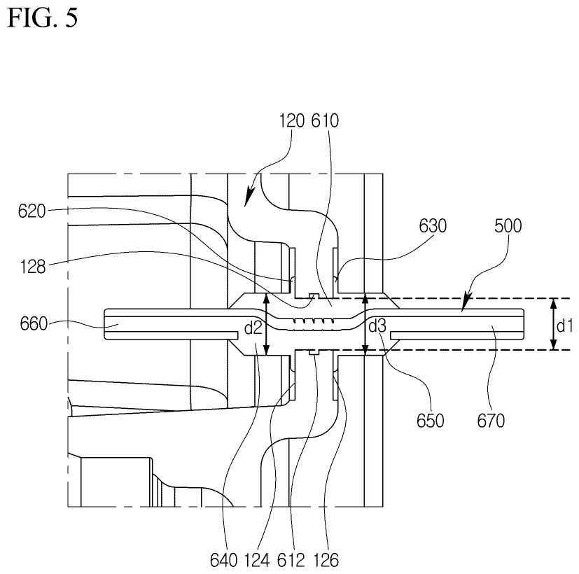

In this case, as shown in FIG. 5, a maximum width d2 of a cross section of the second injection-molded portion 640 and a maximum width d3 of a cross section of the third injection-molded portion 650 are formed to be larger than the maximum width d1 of the cross section of the first injection-molded portion 610. In addition, the maximum width d2 of the cross section of the second injection-molded portion and the maximum width d3 of the cross section of the third injection-molded portion in the direction perpendicular to the direction in which the plurality of terminal pins 500 are spaced apart from each other are formed to be smaller than the width w1 of the first injection-molded surface 620 and the width w2 of the second injection-molded surface 630. In the present embodiment, the maximum width d2 of the cross section of the second injection-molded portion 640 and the maximum width d3 of the cross section of the third injection-molded portion 650 are the same.

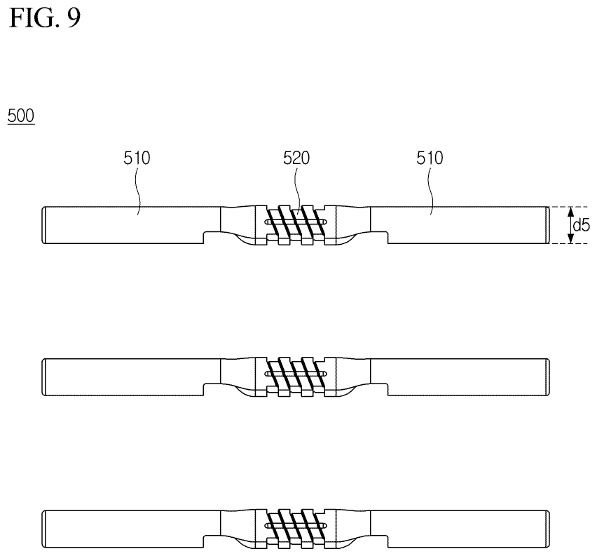

In the present embodiment, as shown in FIG. 9, each terminal pin 500 includes a cylindrical portion 510 having a hollow at both ends, and a deformation portion 520 disposed between the cylindrical portions 510 at both ends and surrounded by the fixing unit 600. Unlike the cylindrical portion 510, the deformation portion 520 has a shape that is flatly deformed after being cut. However, the present invention is not limited thereto, and the shape of the terminal pin 500 may have various shapes such as a plate type and the like.

The deformation portion 520 is surrounded by the first injection-molded portion 610, the first injection-molded surface 620, the second injection-molded surface 630, the second injection-molded portion 640, and the third injection-molded portion 650.

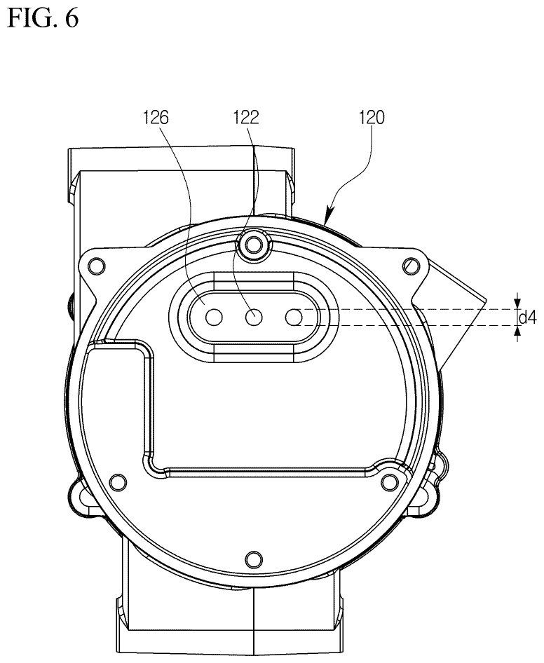

In this case, as shown in FIGS. 6 and 9, a minimum diameter d4 of the through hole 122 is preferably 2 mm or larger than an outer diameter d5 of the terminal pin 500. This is to ensure that the fixing unit 600 is injection-molded by a predetermined amount or more between the terminal pin 500 and the through hole 122 of the partition wall of the motor housing 120 to reliably secure the terminal pin 500.

In addition, in order to increase the adhesion between the terminal pin 500 and the fixing unit 600, a central portion of the terminal pin 500, more specifically, the deformation portion 520, disposed inside the first injection-molded portion 610 may have an uneven shape.

As described above, when the terminal pin 500 has cylindrical portions 510 having a hollow at both ends, the fixing unit 600 may be injection-molded into the hollows of the cylindrical portions 510 at both ends. That is, the fixing unit 600 may further include a fourth injection-molded portion 660 connected to the second injection-molded portion 640 and injection-molded into the hollow of the cylindrical portion 510, and a fifth injection-molded portion 670 connected to the third injection-molded portion 650 and injection-molded into the hollow of the cylindrical portion 510.

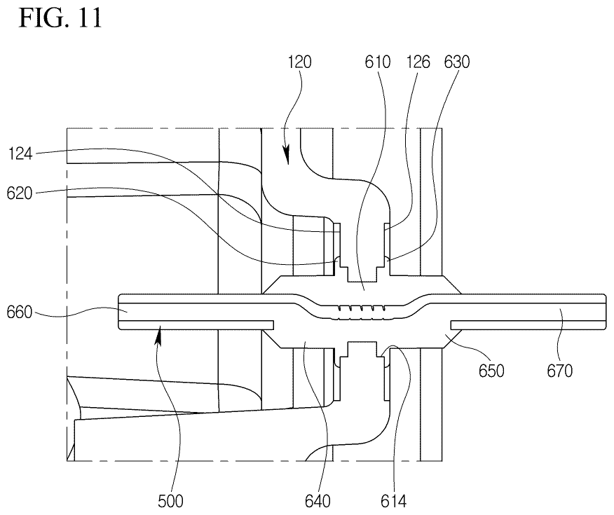

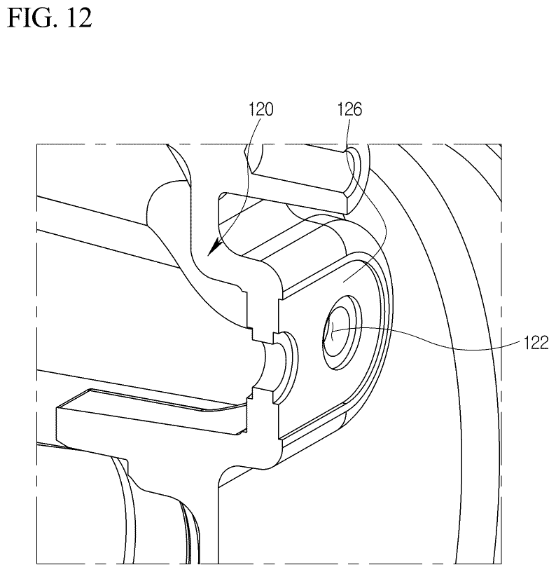

Next, an electric compressor according to a second embodiment of the present invention will be described with reference to FIGS. 11 and 12.

Since the electric compressor according to the second embodiment differs from the electric compressor according to the first embodiment only in a component for additionally securing the location of the terminal pin 500, this will be described in detail.

In the present embodiment, the slot 128 and the protrusion 612 are omitted, and instead, a counterbore shape and a stepped portion 614 are provided. Specifically, the through hole 122 of the partition wall of the motor housing 120 has a counterbore shape in which a width of both ends increases outward, and the stepped portion 614 corresponding to the counterbore shape is provided on both ends of the first injection-molded portion 610.

In the case of forming the counterbore shape in this way, processing is easier than forming the slot 128.

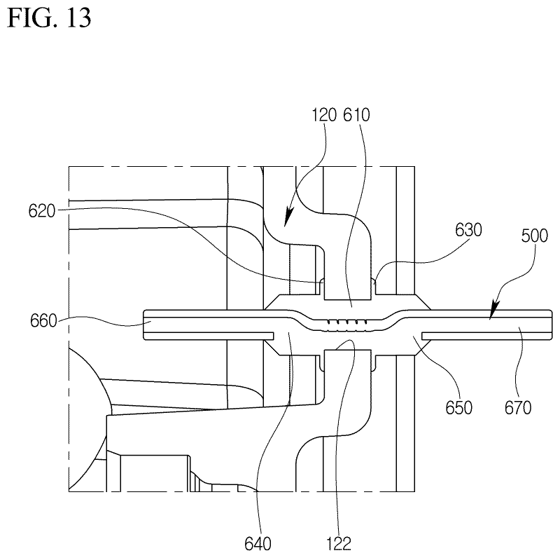

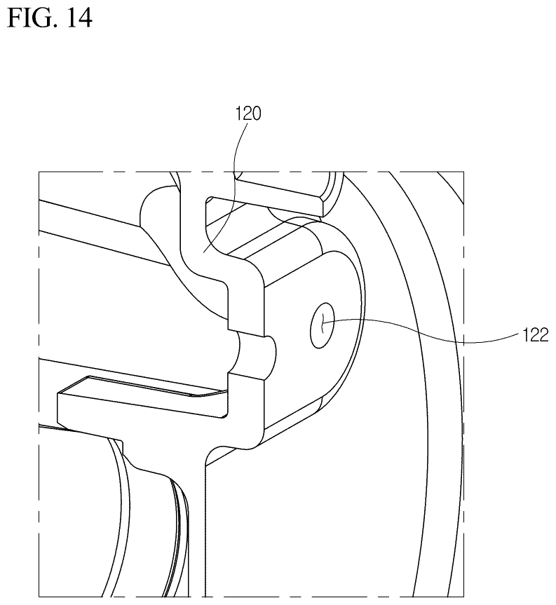

Next, an electric compressor according to a third embodiment of the present invention will be described with reference to FIGS. 13 and 14.

In the third embodiment, the fixing unit 600 includes the first injection-molded portion 610, the first injection-molded surface 620, the second injection-molded surface 630, the second injection-molded portion 640, the third injection-molded portion 650, the fourth injection-molded portion 660, and the fifth injection-molded portion 670 as in the first embodiment, and compared to the first embodiment, the first seating surface 124 and the second seating surface 126 are not formed, and the component for additionally securing the location of the terminal pin 500 is not provided.

Specifically, the first injection-molded surface 620 comes into contact with a flat one end surface of the partition wall of the motor housing 120, and the second injection-molded surface 630 comes into contact with a flat other end surface of the partition wall of the motor housing 120. In this case, since the terminal pin 500 is integrated into the partition wall of the motor housing 120 by injection-molded of the fixing unit 600, surface processing may be omitted for the one end surface and the other end surface of the partition wall of the motor housing 120.

In addition, since the configuration for additionally securing the location of the terminal pin 500 is not an essential component, the configuration of the slot 128 and the protrusion 612 is omitted in the present embodiment.

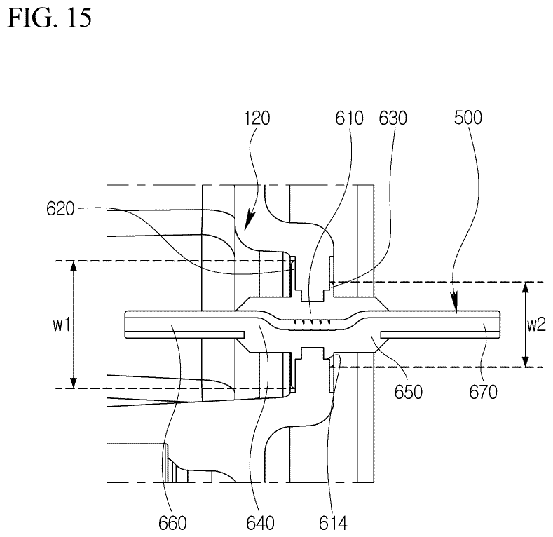

Finally, an electric compressor according to a fourth embodiment of the present invention will be described with reference to FIG. 15.

The electric compressor according to the fourth embodiment includes the same configuration as the electric compressor according to the second embodiment, and the first injection-molded surface 620 is formed to be wider than the second injection-molded surface 630. That is, the width w1 of the first injection-molded surface 620 is larger than the width w2 of the second injection-molded surface 630.

This is because there is a possibility of leakage of refrigerant on the one end surface of the partition wall of the motor housing 120 in which the motor unit 200 is disposed. Accordingly, by configuring the first injection-molded surface 620 on the motor unit 200 side to be wider than the second injection-molded surface 630 on the inverter unit 400 side, the wider the first injection-molded surface 620, the closer the first injection-molded surface 620 is to the inverter unit 400, thereby preventing leakage of refrigerant.

According to the present invention, a through hole through which a terminal pin electrically connecting an inverter unit to a motor unit passes can be formed in a partition wall, and the terminal pin can be integrally injection-molded into the through hole together with a fixing unit, thereby sealing a gap between the terminal pin and a housing without a separate sealing member and an assembly member, and enabling modularization of the housing and the terminal pin.

In this way, when the terminal pin is integrated with the housing through the fixing unit, unlike the conventional one, since the assembly member and the sealing member are not required, the number of components and assembly work can be reduced, and the weight can also be reduced.

In addition, by using the fixing unit injection-molded with a plastic material, the cost can be reduced compared to the glass welding used conventionally.

It should be understood that effects of the present invention are not limited to the above effects and include all effects inferrable from the configuration of the invention described in the detailed description or claims of the present invention.

The present invention is not limited to the above specific embodiments and descriptions, and those skilled in the art to which the present invention pertains can make various modifications without departing from the gist of the present invention claimed in the claims, and such modifications are within the scope of the present invention.

### DESCRIPTION OF REFERENCE NUMERALS

| | |
|---|---|
| 1: electric compressor | 100: housing |
| 120: motor housing | 122: through-hole |
| 124: first seating surface | 126: second seating surface |
| 128: slot | 140: compression housing |
| 160: inverter housing | 200: motor unit |
| 210: rotational shaft | 220: rotor |
| 230: stator | 300: compression unit |
| 310: orbiting scroll | 320: fixed scroll |
| 400: inverter unit | 410: circuit board |
| 420: inverter cover | 500: terminal pin |
| 510: cylindrical portion | 520: deformation portion |
| 600: fixing unit | |
| 610: first injection-molded portion | |
| 612: protrusion | 614: stepped portion |
| 620: first injection-molded surface | |
| 630: second injection-molded surface | |
| 640: second injection-molded portion | |
| 650: third injection-molded portion | |
| 660: fourth injection-molded portion | |
| 670: fifth injection-molded portion | |

What is claimed is:

1. An electric compressor comprising:
a housing in which a compression unit for compressing a refrigerant and a motor unit for driving the compression unit are disposed and in which the refrigerant flows; and
an inverter unit that is disposed on one side of the housing and controls the motor unit, wherein a plurality of through holes are formed in a partition wall located between the motor unit and the inverter unit, and
the electric compressor further comprises:
a plurality of terminal pins electrically connecting the motor unit to the inverter unit by passing through the plurality of through holes, respectively; and
a fixing unit having a plurality of first injection-molded portions injection-molded into the plurality of through holes, respectively, while surrounding at least a portion of each of the plurality of terminal pins.

2. The electric compressor of claim 1, wherein the fixing unit is injection-molded using a plastic material.

3. The electric compressor of claim 1, wherein the fixing unit further has a first injection-molded surface that comes into contact with a first end surface of the partition wall facing the motor unit and connects the plurality of first injection-molded portions, and a second injection-molded surface that comes into contact with a second end surface of the partition wall facing the inverter unit and connects the plurality of first injection-molded portions.

4. The electric compressor of claim 3, wherein a width (w1) of the first injection-molded surface and a width (w2) of the second injection-molded surface in a direction perpendicular to a direction in which the plurality of terminal pins are spaced apart from each other are larger than a maximum width (d1) of a cross section of each of the plurality of first injection-molded portions.

5. The electric compressor of claim 3, wherein the first injection-molded surface is formed to be wider than the second injection-molded surface.

6. The electric compressor of claim 3, wherein a first seating surface recessed so that the first injection-molded surface is seated is formed on the first end surface of the partition wall, and a second seating surface recessed so that the second injection-molded surface is seated is formed on the second end surface of the partition wall.

7. The electric compressor of claim 3, wherein an adhesive is applied to a portion of the first end surface of the partition wall with which the first injection-molded surface comes into contact and a portion of the second end surface of the partition wall with which the second injection-molded surface comes into contact.

8. The electric compressor of claim 3, wherein the fixing unit further has a plurality of second injection-molded portions extending outward from the first injection-molded surface to surround at least a portion of each of the plurality of terminal pins, and a plurality of third injection-molded portions extending outward from the second injection-molded surface to surround at least a portion of each of the plurality of terminal pins.

9. The electric compressor of claim 8, wherein a maximum width (d2) of a cross section of each of the plurality of second injection-molded portions and a maximum width (d3) of a cross section of each of the plurality of third injection-molded portions are larger than a maximum width (d1) of a cross section of each of the plurality of first injection-molded portion.

10. The electric compressor of claim 1, wherein a slot is formed in an inner surface of the partition wall forming the plurality of through holes, and each of the plurality of first injection-molded portions has a protrusion inserted into the slot.

11. The electric compressor of claim 1, wherein each of the plurality of through holes has a counterbore shape in which a width of both ends increases outward, and a stepped portion corresponding to the counterbore shape is provided on both ends of each of the plurality of first injection-molded portions.

12. The electric compressor of claim 1, wherein a minimum diameter (d4) of the plurality of through holes is 2 mm or more larger than an outer diameter (d5) of each of the plurality of terminal pins.

13. The electric compressor of claim 1, wherein a central portion of each of the plurality of terminal pins disposed inside each of the plurality of first injection-molded portions has an uneven shape.

14. The electric compressor of claim 1, wherein each of the plurality of terminal pins includes a cylindrical portion having a hollow at both ends, and a deformation portion disposed between the cylindrical portion at both ends and surrounded by the fixing unit.

15. The electric compressor of claim 14, wherein the fixing unit is injection-molded to the hollow of the cylindrical portion at both ends.
